(19) United States
(12) Patent Application Publication
(10) Pub. No.: US 2006/0002146 A1
(43) Pub. Date: Jan. 5, 2006

(54) Backlight unit and liquid crystal display device using the same

(75) Inventor: Masatake Baba, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD Technologies, Ltd., Kawasaki (JP)

(21) Appl. No.: 11/170,443

(22) Filed: Jun. 30, 2005

(30) Foreign Application Priority Data
Jul. 1, 2004 (JP) 195880/2004

(51) Int. Cl. F21V 7/04

(52) U.S. Cl. 362/613

(57) ABSTRACT

Light emitted in side surface directions from side-emitting red, green, and blue LEDs which are arranged on an LED array substrate is introduced into a light guide from side surfaces of a groove-shaped recessed portion, and propagates in the light guide. Thus, the three colors are mixed. The light further propagates in the light guide while being reflected at both side end surfaces of the light guide by the function of a reflective sheet and the like. Thus, color mixing progresses. Further, the light is reflected upward by diffuse reflective means provided on the lower surface of the light guide, and emitted as backlight light to the outside through a diffuse sheet.

### BACKGROUND OF THE INVENTION

1. Field of the Invention

The present invention relates to a backlight unit and a liquid crystal display device using the same. In particular, the present invention relates to a backlight unit using light-emitting diodes or the like as light sources, and a liquid crystal display device using this backlight unit.

2. Description of the Related Art

In backlights for transmissive or transflective liquid crystal display devices, cold cathode fluorescent tubes have been mainly used as light sources. Since dedicated lighting circuits are necessary for cold cathode fluorescent tubes and high voltage needs to be handled, the use of light-emitting diodes instead of cold cathode fluorescent tubes has been proposed.

As backlights using LEDs as light sources, there are the following known types: a type in which white light is obtained using white LEDs; and a type in which white light is obtained by arranging three types of LEDs, i.e., red, green, and blue LEDs, and mixing red, green, and blue lights emitted by these LEDs. The type in which white light is obtained using white LEDs is particularly suitable for use in small instruments such as mobile phones and PDAs. However, in the white LEDs, quasi-white light is mainly obtained by applying a YAG phosphor to the blue LEDs. Accordingly, color reproducibility is not sufficient. In particular, the color reproducibility of red is not sufficient compared to those of blue and green. Thus, the white LEDs tend to have a narrow color reproducibility range of red.

The type in which white light is obtained by mixing lights emitted from LEDs of the three colors can improve the above-described color reproducibility of red. LEDs have disadvantages such as low light intensity and expensive price, compared to cold cathode fluorescent tubes. However, in recent years, the improvement of the emission efficiencies of LEDs has progressed. LEDs from which high light intensity can be obtained with large current have been developed, and attempts to commercialize comparatively large backlight units using LEDs are being actively made. With such backlight units, color reproducibility can be improved compared to those of backlight units using only white LEDs.

Such a backlight unit using LEDs has been proposed in, for example, Japanese Patent Translation Publication No. 2003-532273. The outline of this backlight unit will be described. As shown in FIG. 9, a structure is prepared in which a plurality of LEDs 211 are arranged on an end surface of a light guide 203 and in which light-outputting means 231 for outputting light to the outside of the light guide 203 is provided in the lower surface of the light guide 203 in a region far away from the LEDs 211. A plurality of such structures are combined. Further, a diffuser 251 is placed on the front side. The resultant structure is contained in a frame 207, thus constructing a backlight unit 200.

However, in this backlight unit 200, the three colors are mixed by placing the LEDs 211 as light sources on end surfaces of the light guides 203. Accordingly, the picture-frame area outside the effective lighting area of the backlight unit 200 cannot be narrowed. Thus, the outer shape becomes large. Further, since the plurality of light guides 203 are used in a stacked manner, there is the problem that the thickness and weight of the backlight unit 200 become large.

Moreover, in “High-efficiency slim LED backlight system with mixing light guide,” SID 03 DIGEST (43.3), pp. 1262-1265, Yourii Martynov et al. have proposed that a plurality of substrates having side-emitting LEDs arranged in an array form are placed in a box-shaped reflector to be used as a surface light source. However, this backlight unit has the problem that lights emitted from the LEDs of the light source cannot be efficiently mixed over the effective lighting area of the backlight unit. Accordingly, there is the problem that great color variation occurs depending on the distance from the light source.

### SUMMARY OF THE INVENTION

Accordingly, an exemplary feature of the present invention is to provide a backlight unit in which lights from light-emitting elements serving as light sources can be efficiently mixed and which is suitable for miniaturizing the outer shape, and to provide a liquid crystal display device using this backlight unit.

A backlight unit of the present invention includes a light guide and a plurality of light-emitting elements of a side-emitting type. The light guide has an upper surface, a lower surface, and side end surfaces between the upper and lower surfaces. The lower surface has a recessed portion formed therein from which light enters the light guide. The light guide mixes the entering light and emits illuminating light from the upper surface. The plurality of light-emitting elements of the side-emitting type are arranged and mounted on an array substrate, and placed in the recessed portion of the light guide.

Preferably, the recessed portion of the light guide is a groove-shaped recessed portion, and the plurality of light-emitting elements of the side-emitting type are placed in the groove-shaped recessed portion.

Preferably, the groove-shaped recessed portion of the light guide penetrates the light guide, and the plurality of light-emitting elements of the side-emitting type are placed in the groove-shaped recessed portion.

Preferably, prismatic dips and bumps are formed in the lower surface of the light guide.

Preferably, the recessed portion of the light guide is replaced by a plurality of hole-shaped recessed portions, and the plurality of light-emitting elements of the side-emitting type are respectively placed in the plurality of hole-shaped recessed portions.

Preferably, the hole-shaped recessed portions of the light guide penetrate the light guide, and the plurality of light-emitting elements of the side-emitting type are respectively placed in the hole-shaped recessed portions.

Preferably, the plurality of light-emitting elements of the side-emitting type are light-emitting diodes of a side-emitting type.

Preferably, the plurality of light-emitting elements of the side-emitting type are side-emitting red, green, and blue LEDs.

Furthermore, a liquid crystal display device of the present invention includes a backlight unit, a liquid crystal panel, and a frame. The backlight unit includes a light guide and a plurality of light-emitting elements of a side-emitting type. The light guide has an upper surface, a lower surface, and side end surfaces between the upper and lower surfaces. The lower surface has a recessed portion formed therein from which light enters the light guide. The light guide mixes the entering light and emits illuminating light from the upper surface. The plurality of light-emitting elements of the side-emitting type are arranged and mounted on an array substrate, and placed in the recessed portion of the light guide. The liquid crystal panel receives illuminating light of the backlight unit. The frame holds the backlight unit and the liquid crystal panel.

Preferably, the backlight unit of the liquid crystal display device is replaced by a plurality of backlight units provided together, and the liquid crystal panel receives illuminating light from the plurality of backlight units.

Preferably, the plurality of backlight units are sequentially turned on.

In the backlight unit of the present invention, light emitted by the light-emitting elements of the side-emitting type enters the light guide from the recessed portion of the light guide which is around the light-emitting elements, and propagates in the light guide. Thus, respective lights emitted by the light-emitting elements are mixed. That is, in the case where the recessed portion of the light guide is a groove-shaped recessed portion, light emitted by the light-emitting elements of the side-emitting type enters the light guide on both sides of the light-emitting elements, and light mixing occurs. Further, in the case where the recessed portion of the light guide is a hole-shaped recessed portion, light emitted in all directions around the light-emitting elements of the side-emitting type enters the light guide, and light mixing occurs.

In the backlight unit of the present invention, the plurality of light-emitting elements of the side-emitting type are inserted in the recessed portion provided in the lower surface of the light guide. Further, light emitted from the light-emitting elements of the side-emitting type in the side surface directions is introduced into the light guide, and is repeatedly diffused and reflected during propagation in the light guide. Thus, color mixing of light occurs. Accordingly, lights can be efficiently mixed, and light intensity can be made uniform. Thus, backlight light can be obtained which has small color, variation over the effective lighting area and excellent color reproducibility. Additionally, since the light-emitting elements of the side-emitting type are inserted in the recessed portion provided in the lower surface of the light guide, the picture-frame area can be reduced. Further, the thickness can be reduced.

In the liquid crystal display device of the present invention, a backlight unit is used in which light emitted by the light-emitting elements of the side-emitting type enters the light guide from the recessed portion of the light guide that is around the light-emitting elements and propagates in the light guide, and in which the mixing of respective lights emitted by the light-emitting elements thus occurs. Efficiently-mixed illuminating light is supplied from the above-described backlight unit to the liquid crystal panel to illuminate the liquid crystal panel.

With the liquid crystal display device of the present invention, lights can be efficiently mixed, and light intensity can be made uniform. Thus, backlight light can be obtained which has small color variation over the effective lighting area and excellent color reproducibility. Since the liquid crystal panel performs display using this backlight light as illuminating light, the liquid crystal display device itself is thinned and has an outer shape of a narrow picture frame, and display which is excellent in color reproducibility can be realized.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1A is a perspective view for explaining a backlight unit of a first exemplary embodiment of the present invention.

FIG. 1B is a cross-sectional view taken along the I-I line of FIG. 1A.

FIG. 2 is a cross-sectional view of a liquid crystal display device using the backlight unit of the first exemplary embodiment of the present invention.

FIG. 3 is a cross-sectional view for explaining modification 1 of the backlight unit of the first exemplary embodiment of the present invention.

FIG. 4 is a cross-sectional view for explaining modification 2 of the backlight unit of the first exemplary embodiment of the present invention.

FIG. 5 is a perspective view for explaining a backlight unit of a second exemplary embodiment of the present invention.

FIG. 6 is a cross-sectional view taken along the II-II line of FIG. 5.

FIG. 7 is a perspective view for explaining a backlight unit constructed by arranging a plurality of backlight units of the first exemplary embodiment.

FIG. 8 is a cross-sectional view of a liquid crystal display device using the backlight unit shown in FIG. 7.

FIG. 9 is a cross-sectional view of a backlight unit of a related art.

### DESCRIPTION OF THE PREFERRED EMBODIMENTS

Next, preferred embodiments of the present invention will be described with reference to drawings.

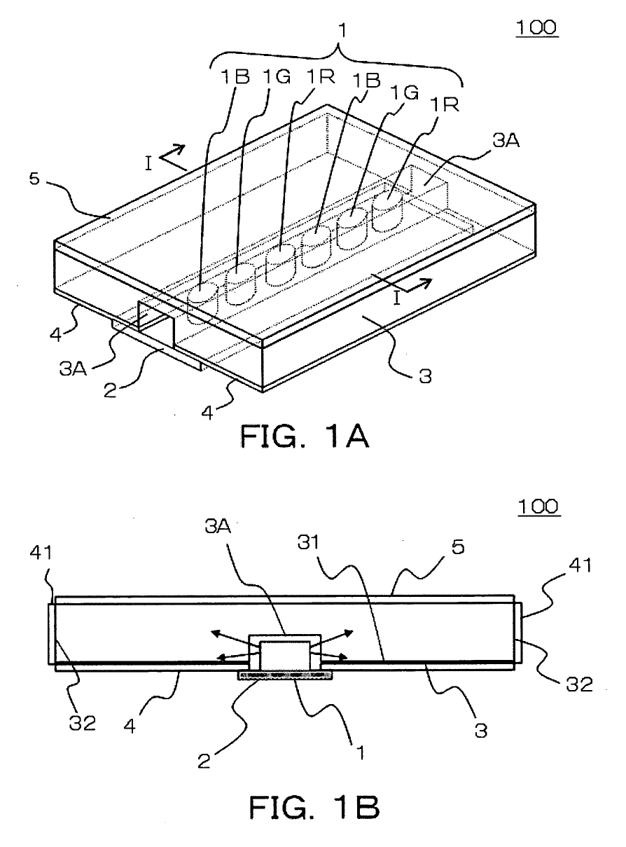

First, a first exemplary embodiment of the present invention will be described in detail with reference to drawings. A description will be given of the case where side-emitting LEDs are used as light-emitting elements of a side-emitting type. As shown in FIG. 1A, the side-emitting LEDs 1 are LEDs 1R, 1G, and 1B, each of which emits monochromatic light of Red, Green, or Blue. These are arranged in order and mounted on an LED array substrate 2. Each side-emitting LED 1 has the following light-emitting characteristics: the angle at which the emission intensity becomes maximum is within +/−20 degrees from the direction parallel to the LED array substrate 2. As such a side-emitting LED, Luxeon series of side-emitting LEDs manufactured by Lumileds Lighting can be used (see the technical document mentioned in “Description of the related art”).

A light guide 3 has upper and lower surfaces, and side end surfaces 32 therebetween. In the lower surface, a recessed portion is formed. The light guide 3 mixes incident light and output it as illuminating light from the upper surface. In this embodiment, the recessed portion of the light guide 3 is a groove-shaped recessed portion 3A. On the lower surface (surface in which the groove-shaped recessed portion 3A is formed) of the light guide 3, diffuse reflective means 31 such as dots or grain is provided. This diffuse reflective means 31 diffuses light entering the light guide 3 and reflects the light to the output surface of the light guide 3. Further, a reflective sheet 4 is placed on the lower surface of the light guide 3, and a diffuse sheet 5 is placed on the upper surface of the light guide 3. The side-emitting LEDs 1R, 1G, and 1B arranged on the LED array substrate 2 are placed in the groove-shaped recessed portion 3A of the above-described light guide 3. Further, a white or specular reflective sheet 41 may be placed on the side end surfaces 32 of the light guide 3 as needed. Furthermore, the side end surfaces 32 of the light guide 3 may be inclined toward the upper or lower surface.

Next, the color mixing function of a backlight unit 100 having the above-described structure will be described. As shown in FIG. 1B, light emitted in the side surface directions from the side-emitting red LEDs 1R, the side-emitting green LEDs 1G, and the side-emitting blue LEDs 1B arranged on the LED array substrate 2 is introduced into the light guide 3 from the side surfaces of the groove-shaped recessed portion 3A. Further, the light propagates in the light guide 3, and the three colors are mixed. There is no optical interface in the light guide 3. Accordingly, the light propagates in the light guide 3 while being reflected at both side end surfaces 32 of the light guide 3 by the function of the reflective sheet 41 and the like, diffused by the diffuse reflective means 31, and the like, whereby color mixing progresses. Furthermore, the light is reflected upward by the diffuse reflective means 31 provided on the lower surface of the light guide 3, and emitted as backlight light to the outside through the diffuse sheet 5. In order to obtain a more efficient color mixing function, design is performed in consideration of an angle range in which the emission intensity of light emitted from each side-emitting LED 1 becomes maximum, the distances from the recessed portion to the side end surfaces 32 of the light guide 3, the thickness of the light guide 3, and the like.

In the backlight unit 100 of this embodiment, the side-emitting LEDs 1 are inserted in the groove-shaped recessed portion 3A provided in the light guide 3, and light emitted from the side-emitting LEDs 1 in the side surface directions is introduced into the light guide 3 on both sides of the LEDs 1. Thus, the color mixing of light occurs. A color mixing effect obtained increases as the distance from the LEDs 1 increases. This is because a sufficient distance can be ensured by allowing light to be reflected at the side end surfaces 32 of the light guide 3 even in the case where it is difficult to ensure a distance. In the backlight unit 100 of this embodiment, the three colors can be efficiently mixed at low cost using the light guide 3 having a comparatively simple shape. Further, backlight light can be obtained which has small color variation over the effective lighting area of the backlight unit and excellent color reproducibility. Additionally, since the side-emitting LEDs 1 are inserted in the groove-shaped recessed portion 3A provided in the light guide 3, the picture-frame area of the backlight unit 100 can be reduced. Furthermore, the thickness of the backlight unit 100 can be reduced.

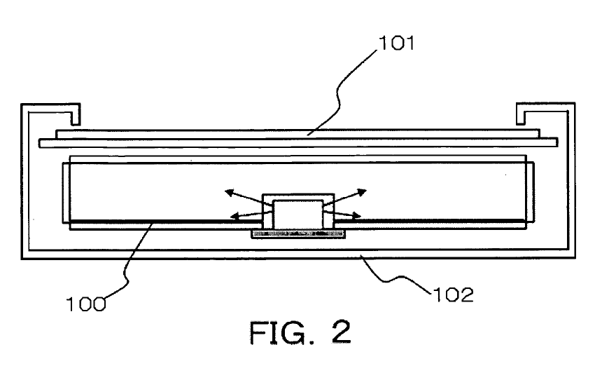

Next, a liquid crystal display device of this embodiment will be described with reference to FIG. 2. This liquid crystal display device uses the above-described backlight unit 100. The liquid crystal display device has the backlight unit 100, a liquid crystal panel 101 which receives illuminating-light of the backlight unit 100, and a frame 102 which holds the backlight unit 100 and the liquid crystal panel 101.

In the above-described liquid crystal display device, since the aforementioned backlight unit 100 is used, the three colors can be efficiently mixed at low cost. Backlight light can be obtained which has small color variation over the effective lighting area and excellent color reproducibility. Since the liquid crystal panel performs display using this backlight light as illuminating light, the liquid crystal display device itself is thinned and has an outer shape of a narrow picture frame. Thus, display which is excellent in color reproducibility can be realized.

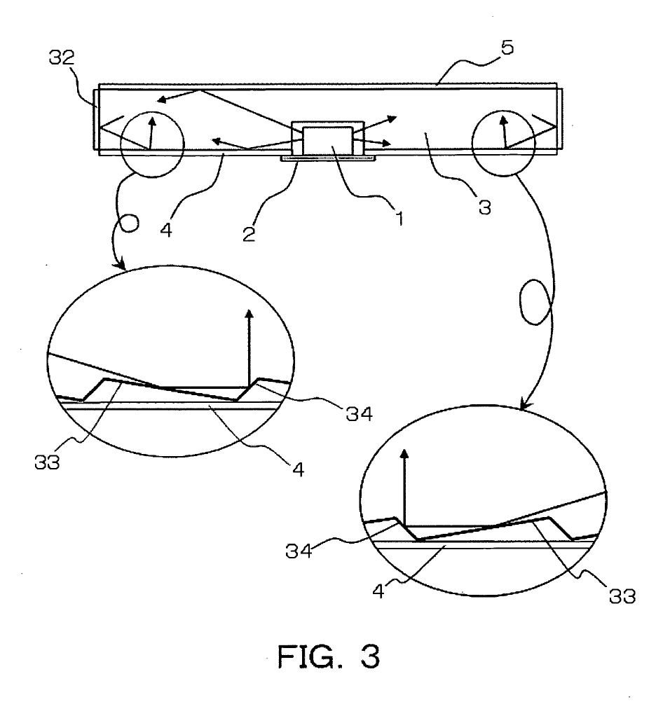

Next, a modification of the backlight unit of the first exemplary embodiment will be described. Modification 1 is the case where prismatic dips and bumps constitute the diffuse reflective means on the lower surface of the light guide 3. In this modification 1, as shown in FIG. 3, on the lower surface of the light guide 3, gentle slopes 33 and steep slopes 34 are alternately provided to form the prismatic dips and bumps. The shapes of the prismatic dips and bumps are opposite between the left and right sides of the groove-shaped recessed portion 3A of the light guide 3 in the drawing. Light emitted from the side-emitting LEDs 1 to enter the light guide 3 on both sides thereof propagates in the light guide 3 at the gentle slopes 33 of the lower surface of the light guide 3 and a plane surface of the upper surface thereof by total reflection. Further, the light is reflected at the side end surfaces 32, and reflected upward by the steep slopes 34 of the lower surface of the light guide 3, and can be emitted from the plane surface of the upper surface.

Thus, sufficient color mixing is performed for the time when the light propagates in the light guide 3. Further, in this modification 1, since total reflection is utilized, light loss is small. Accordingly, efficient light utilization can be expected to be realized.

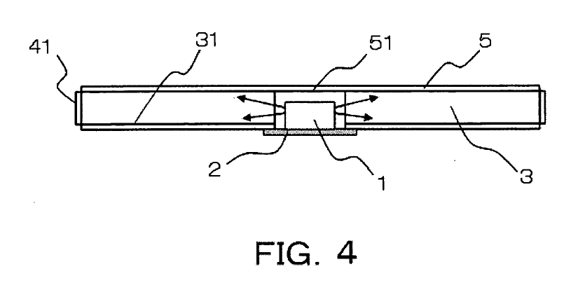

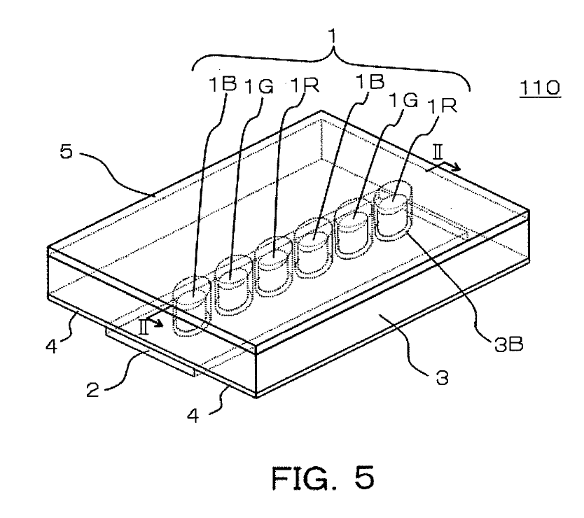

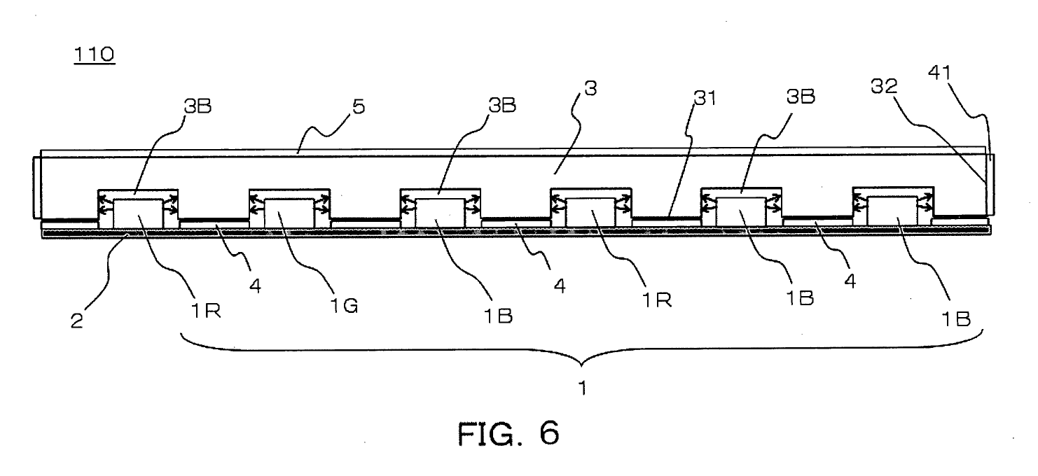

Furthermore, another modification of the backlight unit of the first exemplary embodiment will be described. In modification 2, the light guide 3 is thinned. As shown in FIG. 4, the light guide 3 does not exist above the side-emitting LEDs 1. That is, two rectangular light guides 3 are placed to face each other across the LEDs 1, and the diffuse sheet 5 is placed to cover the LEDs 1 and the light guides 3. The thickness of the light guides 3 can be made approximately equal to the heights of the LEDs 1.

Moreover, though the LEDs 1 are side-emitting LEDs, it is considered that light having low emission intensity is also emitted from the top surfaces thereof in actuality. Accordingly, optical-path conversion means 51 for blocking, diffusing, and reflecting light emitted directly above the LEDs 1 may be provided on the diffuse sheet 5 facing the LEDs 1. For example, this optical-path conversion means 51 can be realized by printing a white or semitransparent material onto the diffuse sheet 5, attaching tape thereto, or chemically treating or thermally processing the diffuse sheet 5 itself. This modification can be expected to provide a thinning effect in addition to the major effects of the aforementioned first exemplary embodiment and modification 1.

Next, a second exemplary embodiment of the present invention will be described. A backlight unit 110 of this embodiment differs from the backlight unit 100 of the first exemplary embodiment in the structure of the light guide 3 and the constitution around the light guide 3.

That is, the recessed portion provided in the lower surface of the light guide 3 is replaced by a plurality of cylindrical hole-shaped recessed portions 3B, and a plurality of side-emitting LEDs 1 (red LEDs 1R, green LEDs 1G, and blue LEDs 1B) arranged and mounted on a LED array substrate 2 are respectively inserted into the plurality of hole-shaped recessed portions 3B. On the lower surface of the light guide 3, a diffuse reflective means 31 such as dots or grain is provided. The diffuse reflective means 31 diffuses light entering the light guide 3, and reflects the light to the output surface of the light guide 3. Further, a reflective sheet 4 is placed on the lower surface of the light guide 3, and a diffuse sheet 5 is placed on the upper surface of the light guide 3.

Next, the color mixing function of the above-described backlight unit 110 will be described. Light emitted in the side surface directions from the side-emitting red LEDs 1R, the side-emitting green LEDs 1G, and the side-emitting blue LEDs 1B arranged on the LED array substrate 2 is introduced into the light guide 3 from the side surfaces of the hole-shaped recessed portions 3B. Further, the light propagates in the light guide 3, and the three colors are mixed. There is no optical interface in the light guide 3. Accordingly, the light propagates in the light guide 3 while being reflected at both side end surfaces 32 of the light guide 3 by the function of a reflective sheet 41 and the like, diffused by the diffuse reflective means 31, and the like, whereby the mixing of colors progresses. Furthermore, the light is reflected upward by the diffuse reflective means 31 provided on the lower surface of the light guide 3, and emitted as backlight light to the outside through the diffuse sheet 5.

In the above-described backlight unit 110 of this embodiment, light emitted from the side-emitting LEDs 1 in the side surface directions is efficiently introduced into the light guide 3 over all directions around the LEDs 1 because air layers are small. Thus, sufficient mixing of light occurs. This is because a sufficient distance can be ensured by allowing light to be reflected at the side end surfaces 32 of the light guide 3 even in the case where it is difficult to ensure a distance. Accordingly, in the backlight unit 110 of this embodiment, the three colors can be efficiently mixed compared to in the case of the backlight unit of the first exemplary embodiment, and backlight light can be obtained which has small color variation over the effective lighting area of the backlight unit. Additionally, since the side-emitting LEDs 1 are inserted in the hole-shaped recessed portions 3B provided in the light guide 3, the picture-frame area of the backlight unit 110 can be reduced. Furthermore, the thickness of the backlight unit 110 can be reduced.

The backlight unit 110 of this embodiment may also be constructed so that the recessed portions become through holes and that the light guide 3 does not exist above the side-emitting LEDs 1, by thinning the light guide 3 as shown in FIG. 4 of modification 2 of the first exemplary embodiment. In this case, as in modification 2 of the first exemplary embodiment, an optical-path conversion means 51 for blocking, diffusing, and reflecting light emitted by the LEDs 1 may be provided in the portion of the diffuse sheet 5 which is adjacent to the LEDs 1. Further, a white or specular reflective sheet 41 may be placed on the side end surfaces 32 of the light guide 3 as needed. Furthermore, the side end surfaces 32 of the light guide 3 may be inclined toward the upper or lower surface.

Up to this point, the preferred embodiments have been described. However, the present invention is not limited to these. It would be possible to make various modifications and additions. For example, the light-emitting elements of a side-emitting type are not limited to the aforementioned light-emitting diodes (LEDs). Other light-emitting elements, e.g., laser diodes (LDs), would also be usable as long as they are light sources having maximum emission intensities in the side surface directions.

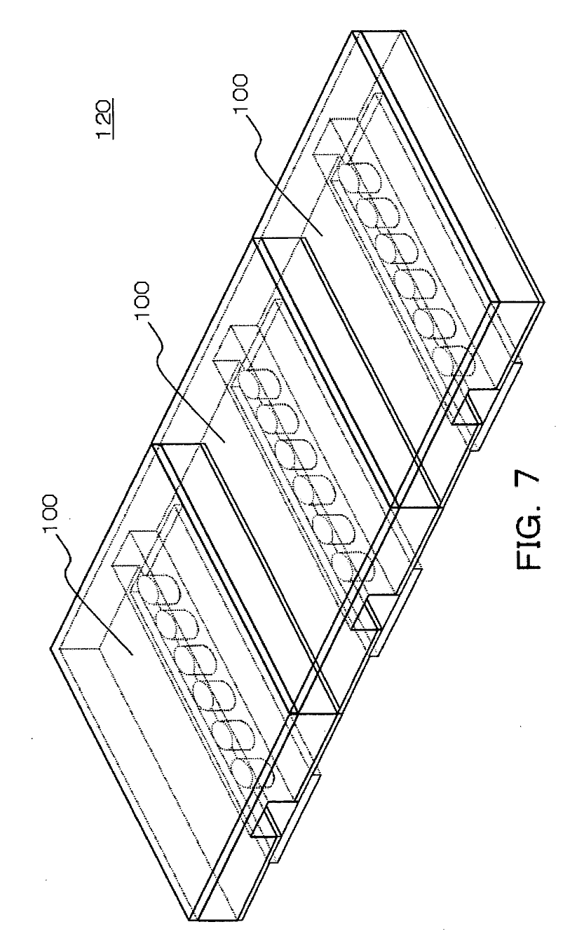

Furthermore, FIG. 2 shows a liquid crystal display device having a structure in which one backlight unit is placed for one liquid crystal panel. However, it is also conceivable to provide a plurality of backlight units together in such a manner that the display area of one liquid crystal panel is divided. Such a backlight unit and a liquid crystal display device using this backlight unit will be described with reference to drawings. FIG. 7 shows the case where three backlight units 100 of the first exemplary embodiment shown in FIG. 1A are provided together to constitute a backlight unit 120. The structure and function of each backlight unit 100 have been described in the first exemplary embodiment, and therefore will not be further described. In the backlight unit 120 having the above-described constitution, it can be considered that there are cases where all of the backlight units 100 are used to be simultaneously turned on, and where the backlight units 100 are used to be sequentially turned on or off by time division. Such a backlight unit 120 can realize a backlight unit for a larger liquid crystal panel than the backlight unit 100 shown in FIGS. 1A and 1B can.

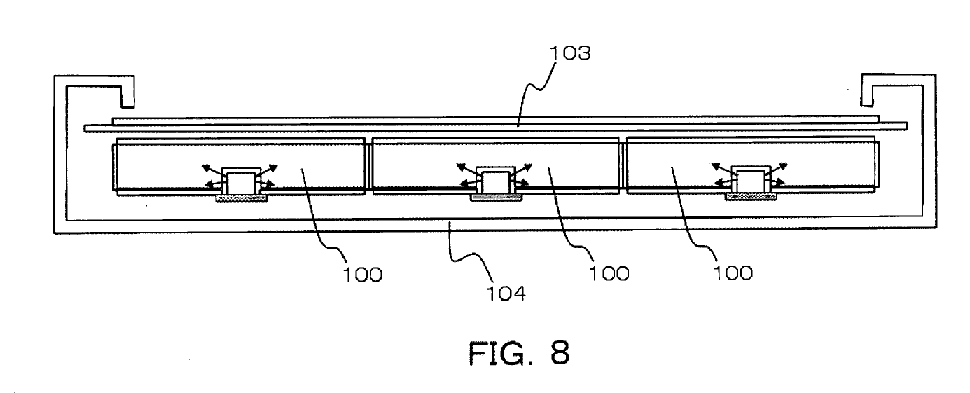

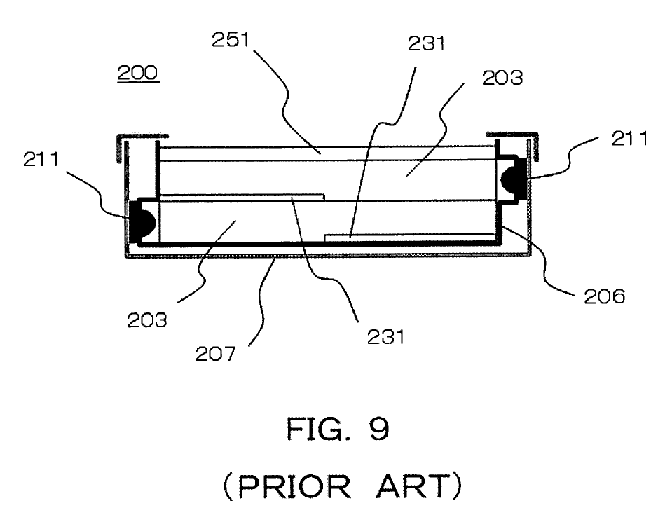

Next, a liquid crystal display device using this backlight unit 120 will be described with reference to FIG. 8. This liquid crystal display device has the backlight unit 120 in which three backlight units 100 are provided together, a liquid crystal panel 103 which receives illuminating light of the backlight unit 120, and a frame 104 which holds the backlight unit 120 and the liquid crystal panel 103. The above-described liquid crystal display device has a constitution in which the plurality of backlight units 100 are provided together for one liquid crystal panel 103 in such a manner that the display area is divided. In the above-described liquid crystal display device, the three colors can be efficiently mixed at low cost because of the use of the above-described backlight unit 120. Backlight light can be obtained which has small color variation over the effective lighting area and excellent color reproducibility. Since the liquid crystal panel performs display using this backlight light as illuminating light, the liquid crystal display device itself is thinned and has an outer shape of a narrow picture frame. Thus, display which is excellent in color reproducibility can be realized. Further, a larger liquid crystal display device can be realized. Furthermore, a blur at the time when a moving video picture is displayed on the liquid crystal panel 103 would be effectively eliminated by providing the above-described plurality of backlight units 100 together for the liquid crystal panel 103 and sequentially turning on the backlight units 100 in correspondence with the drive of the liquid crystal panel 103.

Additionally, conceivable application examples of the backlight units of the present invention include backlight units for liquid crystal display devices and various display materials (advertisement panels and the like), and general lighting devices.

Although preferred embodiments of the invention has been described with reference to the drawings, it will be obvious to those skilled in the art that various changes or modifications may be made without departing from the true scope of the invention.

What is claimed is:

1. A backlight unit comprising:
a light guide having an upper surface, a lower surface, and side end surfaces between the upper and lower surfaces, the lower surface having a recessed portion formed therein from which light enters the light guide, the light guide mixing the entering light and emitting illuminating light from the upper surface; and
a plurality of light-emitting elements of a side-emitting type arranged and mounted on an array substrate, the plurality of light-emitting elements of the side-emitting type being placed in the recessed portion of the light guide.

2. The backlight unit according to claim 1, wherein the recessed portion of the light guide is a groove-shaped recessed portion, and the plurality of light-emitting elements of the side-emitting type are placed in the groove-shaped recessed portion.

3. The backlight unit according to claim 2, wherein the groove-shaped recessed portion of the light guide penetrates the light guide, and the plurality of light-emitting elements of the side-emitting type are placed in the groove-shaped recessed portion.

4. The backlight unit according to claim 2, wherein prismatic dips and bumps are formed in the lower surface of the light guide.

5. The backlight unit according to claim 1, wherein the recessed portion of the light guide is replaced by a plurality of hole-shaped recessed portions, and the plurality of light-emitting elements of the side-emitting type are respectively placed in the plurality of hole-shaped recessed portions.

6. The backlight unit according to claim 5, wherein the hole-shaped recessed portions of the light guide penetrate the light guide, and the plurality of light-emitting elements of the side-emitting type are respectively placed in the hole-shaped recessed portions.

7. The backlight unit according to claim 1, wherein the plurality of light-emitting elements of the side-emitting type are light-emitting diodes of a side-emitting type.

8. The backlight unit according to claim 7, wherein the plurality of light-emitting elements of the side-emitting type are side-emitting red, green, and blue LEDs.

9. A liquid crystal display device comprising:
a backlight unit including a light guide and a plurality of light-emitting elements of a side-emitting type; the light guide having an upper surface, a lower surface, and side end surfaces between the upper and lower surfaces, the lower surface having a recessed portion formed therein from which light enters the light guide, the light guide mixing the entering light and emitting illuminating light from the upper surface; the plurality of light-emitting elements of the side-emitting type being arranged and mounted on an array substrate and being placed in the recessed portion of the light guide;
a liquid crystal panel receiving illuminating light of the backlight unit; and
a frame holding the backlight unit and the liquid crystal panel.

10. The liquid crystal display device according to claim 9, wherein the backlight unit is replaced by a plurality of backlight units provided together, and the liquid crystal panel receives illuminating light from the plurality of backlight units.

11. The liquid crystal display device according to claim 10, wherein the plurality of backlight units are sequentially turned on.
